(19) United States
(12) Patent Application Publication
(10) Pub. No.: US 2025/0378702 A1
(43) Pub. Date: Dec. 11, 2025

(54) RAPID OBJECT LABELLING AND ANOMALY DETECTION FOR COMPUTER VISION AUTOMATIC TARGET RECOGNITION SYSTEMS

(71) Applicant: CACI, INC.- FEDERAL, Reston, VA (US)

(72) Inventors: Zachary JORGENSEN, Reston, VA (US); Jonathan VON STROH, Reston, VA (US); Patrick MEDINA, Reston, VA (US); Chase VISS, Reston, VA (US)

(21) Appl. No.: 18/115,642

(22) Filed: Feb. 28, 2023

(51) Int. Cl. G06V 20/70; G06V 10/25; G06V 10/44; G06V 10/762

(52) U.S. Cl. CPC G06V 20/70; G06V 10/25; G06V 10/44; G06V 10/762

(57) ABSTRACT

Methods, systems, and apparatuses, among other things, may label and classify objects via appearance-based clustering for computer vision automatic target recognition (ATR) systems, including automated anomaly detection for objects appearing in an area of interest (AOI).

### FIELD

This application is generally related to methods and apparatuses for labelling, classifying, and/or identifying objects in over-head geospatial or satellite footage.

### BACKGROUND

Manual image or video analysis of geospatial or satellite footage may be expensive and time consuming. For example, many objects may appear in a large area of interest (AOI) being monitored in an automatic target recognition (ATR) system. Analysis of such a large AOI may be expensive and time consuming due to the sheer magnitude of images or video streams that must be consumed by human analysts, e.g., exceeding an amount that can be realistically exploited by human analysts. Moreover, even in cases where computers are utilized to detect general objects, human analysts must perform initial classifications of the detected objects manually (e.g. as a specific model of aircraft or ship) until enough data can be collected to train a machine learning (ML) classifier to label them automatically in the future. This results in a significant amount of tedious, manual labor for analysts.

Additionally, analysts monitoring a given AOI are interested in knowing when unusual objects (e.g., a type of airplane that has never been seen in that AOI before) appear in their AOI, but it can be difficult to manually identify such objects when there are many detections. Moreover, human analysts can easily miss important details due to fatigue and information overload. Consequently, important details may go unnoticed and strategic opportunities may be missed. Accordingly, there is a need to accurately and efficiently analyze imagery to detect, identify, and classify unfamiliar or unusual objects in an AOI.

### SUMMARY

The foregoing needs are met, to a great extent, by the disclosed apparatus, system and method for efficient labelling and classifying of objects via appearance-based clustering for computer vision ATR systems, including automated anomaly detection for objects appearing in an AOI.

One aspect of the application is directed to a method of clustering and/or labelling objects in an AOI. For example, an AOI may be selected by a user. Moreover, the AOI may be associated with one or more of a polygon on a map or a particular event.

In some aspects, a feature vector associated with an object in the AOI may be determined (e.g., by a trained machine learning model). The feature vector may comprise a bounding box associated with the object and a vector of floating point numbers summarizing the visual appearance of the object.

In some aspects, a Euclidean distance between the labeled feature vector and one or more stored feature vectors may be computed. A plurality of feature vectors may be grouped into a cluster (e.g., using hierarchical agglomerative clustering) based on the computed Euclidean distance, such that objects that are similar in appearance and are likely of the same class of object (e.g., a specific model of airplane) will be placed into the same cluster.

A dendrogram depicting a hierarchy of clusters may be built based on the distances between the clusters. Moreover, the dendrogram of clusters may be presented to a user by a user interface or used to enable the user to split or drill down to more granular clusters. Objects may be assigned labels in bulk by the user based on the cluster to which they are assigned.

In some aspects, an anomaly score may be determined (e.g., by a machine learning model) for the object. For example, the anomaly score may be determined using one or more anomaly detection algorithms (e.g., K-Nearest Neighbors anomaly detection). An anomaly may be determined based on comparing the anomaly score to a threshold (e.g., on a per-AOI basis). The anomaly may be removed from a set of detected objects prior to clustering. Moreover, the anomaly may be added to an anomaly cluster to be vetted by a user. For example, confirmation or rejection of the anomaly cluster may be received from a user. As another example, in a case where an anomaly cluster is rejected by a user, the anomaly and/or anomalies making up the anomaly cluster may be added to a set of detections.

The above summary may present a simplified overview of some embodiments of the invention in order to provide a basic understanding of certain aspects of the invention discussed herein. The summary is not intended to provide an extensive overview of the invention, nor is it intended to identify any key or critical elements or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various aspects of the invention and, together with the general description of the invention given above, and the detailed description of the aspects given below, serve to explain the aspects of the invention. These drawings should not be construed as limiting the invention and are intended only to be illustrative.

FIG. 1 is a schematic representation of an architecture of a system for identification, labelling, classification, and/or anomaly detection in over-head geospatial or satellite footage according to an aspect of the application.

FIG. 1A is a schematic representation of a machine learning model according to an aspect of the application.

FIG. 2 is a diagram illustrating a graphic user interface on a computer monitor display according to an aspect of the application.

FIG. 3A is a diagram illustrating a graphic user interface on a computer monitor display according to an aspect of the application.

FIG. 3B is a diagram illustrating a graphic user interface according to an aspect of the application.

FIG. 4 illustrates a feature extractor according to an aspect of the application.

FIG. 5 illustrates an exemplary flowchart of a method for identification, labelling, classification, and/or anomaly detection in over-head geospatial or satellite footage in accordance with the present disclosure.

FIG. 6 illustrates a system diagram of an exemplary communication network node.

FIG. 7 illustrates a block diagram of an exemplary computing system.

### DETAILED DESCRIPTION

In this respect, before explaining at least one aspect of the invention in detail, it is to be understood that the invention is not limited in its application to the details of construction and to the arrangements of the components set forth in the following description or illustrated in the drawings. The invention is capable of aspects or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” “one aspect,” “an aspect,” “one or more aspects,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

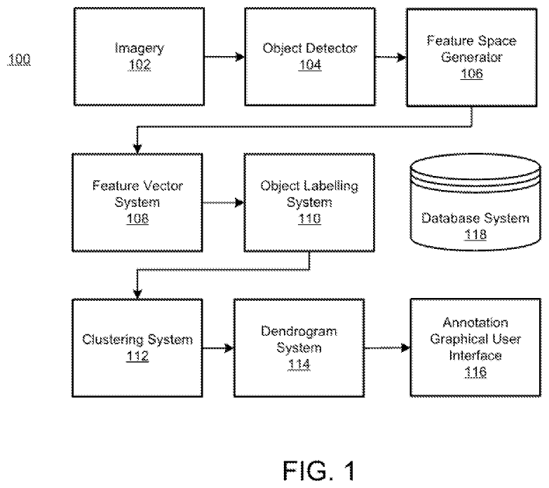

According to some aspects, FIG. 1 illustrates a schematic representation of an architecture of a system 100 for identification, labelling, classification, and/or anomaly detection in over-head geospatial or satellite footage according to an aspect of the application. For example, the system 100 may receive imagery from an over-head geospatial system and identify, label, and or classify objects detected in an AOI. In some aspects, a modular architecture may allow for integration of different identification, labelling, classification, and/or anomaly detection methods into the system 100.

In an aspect, the system 100 may receive imagery 102, e.g., one or more images from over-head geospatial or satellite image system. Moreover, the imagery 102 may comprise archived images, video, or live video streams. In some aspects, the imagery 102 may be received via a wired or wireless network connection from a database (e.g., a server storing image data) or an imaging system. For example, an imaging system may include a satellite, an aerial vehicle (e.g., a manned or unmanned aerial vehicle), a fixed camera (e.g., a security camera, inspection camera, traffic light camera, etc.), a portable device (e.g., mobile phone, head-mounted device, video camera, etc.), or any other form of electronic image capture device. Moreover, the system 100 may receive the one or more imagery 102 via a wired or wireless network connection.

According to some aspects, imagery 102 may include ground based footage, aerial, or near-aerial footage. According to some aspects, FIG. 1 illustrates a schematic representation of an architecture of a system 100 for detecting objects of interest, classifying the objects of interest, and/or labelling the objects of interest in an AOI according to an aspect of the application. Some aspects employ machine learning and/or ANNs to detect, identify, group, classify, and/or label objects. For example, the system 100 may receive imagery 102 associated with an AOI. The imagery associated with the AOI may contain thousands of images (e.g., overhead images) over a large geographic area. The system 100 may provide continuous support to analysts by enabling the analysts to train underlying machine learning algorithms on targets relevant to their AOI.

According to some aspects, an object detector 104 may detect one or more objects in the AOI. The object detector 104 may train a detection model to ensure that all objects (e.g., of interest to a user) are detected in imagery 102 within acceptable error margins. Moreover, the object detector 104 may detect objects that have been previously classified as well as objects that have not been previously classified.

A feature space may be determined for the one or more objects by a feature space generator 106 (e.g., an unsupervised, semi-supervised, or fully supervised neural network). A feature vector system 108 may analyze (e.g., based on feature extraction) the detected objects in the feature space by determining a feature vector for each object. For example, the feature vector may include a bounding box associated with the object and/or may summarize the visual appearance of the object as a vector of floating point numbers. Feature space generator 106 and/or feature vector system 108 may extend to different AOIs and different types of objects without retraining, e.g., allowing for identification of new objects of interest. For example, a fully supervised Siamese Neural Network may be used for feature extraction. Moreover, both unsupervised and semi-supervised feature extraction architectures may be used for feature extraction.

An object labelling system 110 may label a feature vector based on one or more characteristics of the detected object associated with the feature vector. In some aspects, a clustering system 112 may utilize a Euclidean distance calculator to compute a Euclidean distance between the labeled feature vector and one or more stored feature vectors.

In some aspects, the clustering system 112 may group a plurality of feature vectors into a cluster (e.g., using hierarchical agglomerative clustering) based on the Euclidean distance computed by the Euclidean distance calculator. For example, the clustering system 112 may reduce feature dimensionality of feature vectors prior to clustering. Moreover, the clustering system 112 may group like objects close together, e.g., regardless of variables like look angle and environment. A dendrogram system 114 may build a dendrogram of clusters based on and/or depicting a hierarchy of the clusters. In some aspects, clustered object classes may be presented to a user (e.g., an analyst) to facilitate rapid labelling of new detections by labeling clusters in bulk.

According to some aspects, the dendrograms generated by the dendrogram system 114 may be presented to a user by an annotation graphical user interface 116 and/or stored in a database system 118. For example, the database system 118 may encompass storage of dendrograms, as well as one or more of labeled feature vectors (e.g., as determined by object labelling system 110) or clusters (as determined by clustering system 112).

As the system 100 identifies and labels new objects of interest, learned features may be used by the system 100 to quickly label future examples of the same object in that AOI by propagating labels within clusters. In this way, new campaigns and categories may be initialized by the system 100 using previous data, reducing the amount of time needed to achieve a mature detection/classification model. According to some aspects, in addition to locating clusters of frequently seen objects or features of interest within an AOI, unique, anomalous, and/or dissimilar objects or features that may have only been seen in the AOI a few times may be identified and may be correlated to events of interest.

As envisaged in the application, and particularly in regard to the ML model shown in the exemplary embodiment in FIG. 1A, the terms artificial neural network (ANN) and neural network (NN) may be used interchangeably. An ANN may be configured to determine a classification (e.g., a feature, characteristic, or type of an object in an AOI) based on identified information. An ANN is a network or circuit of artificial neurons or nodes, and it may be used for predictive modeling. The prediction models may be and/or include one or more neural networks (e.g., deep neural networks, artificial neural networks, or other neural networks), other ML models, or other prediction models.

Disclosed implementations of ANNs may apply a weight and transform the input data by applying a function, where this transformation is a neural layer. The function may be linear or, more preferably, a nonlinear activation function, such as a logistic sigmoid, hyperbolic tangent function (Tanh), or rectified linear unit (ReLU) function. Intermediate outputs of one layer may be used as the input into a next layer. The neural network through repeated transformations learns multiple layers that may be combined into a final layer that makes predictions. This training (i.e., learning) may be performed by varying weights or parameters to minimize the difference between predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

An ANN is characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. In an exemplary embodiment, hyperparameters are set before learning and model parameters can be set through learning to specify the architecture of the ANN.

Learning rate and accuracy of an ANN rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters.

The hyperparameters may include initial values of weights and biases between nodes, mini-batch size, iteration number, learning rate, and so forth. Furthermore, the model parameters may include a weight between nodes, a bias between nodes, and so forth.

In general, the ANN is first trained by experimentally setting hyperparameters to various values. Based on the results of training, the hyperparameters can be set to optimal values that provide a stable learning rate and accuracy.

A convolutional neural network (CNN) may comprise an input and an output layer, as well as multiple hidden layers. The hidden layers of a CNN typically comprise a series of convolutional layers that convolve with a multiplication or other dot product. The activation function is commonly a ReLU layer and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

In some embodiments, the learning of models 164 may be of reinforcement, supervised, semi-supervised, and/or unsupervised type. For example, there may be a model for certain predictions that is learned with one of these types but another model for other predictions may be learned with another of these types.

Supervised learning is the ML task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of ML that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data).

Semi-supervised learning makes use of both labeled and unlabeled data points. The data set may be split evenly by labeled and unlabeled data points for semi-supervised learning. Alternatively, semi-supervised learning may involve a certain percentage of labeled data points and a remaining percentage of unlabeled data points.

Models 164 may analyze made predictions against a reference set of data called the validation set. In some use cases, the reference outputs resulting from the assessment of made predictions against a validation set may be provided as an input to the prediction models, which the prediction model may utilize to determine whether its predictions are accurate, to determine the level of accuracy or completeness with respect to the validation set, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, training component 132 in the architecture 1000 illustrated in FIG. 1A may implement an algorithm for building and training one or more deep neural networks. A used model may follow this algorithm and already be trained on data. In some embodiments, training component 132 may train a deep learning model on training data 162 providing even more accuracy after successful tests with these or other algorithms are performed and after the model is provided a large enough dataset.

In an exemplary embodiment, a model implementing a neural network may be trained using training data from storage/database 162. For example, the training data obtained from prediction database 160 of FIG. 1A may comprise hundreds, thousands, or even many millions of pieces of information. The training data may also include past objects 180 associated with one or more objects in an AOI. Model parameters from the training data 162 and/or past objects 180 may include but is not limited to historical data regarding one or more features, characteristics, classifications, and/or anomalies associated with one or more objects. Weights for each of the model parameters may be adjusted through training.

The training dataset may be split between training, validation, and test sets in any suitable fashion. For example, some embodiments may use about 60% or 80% of the known objects or anomalies for training or validation, and the other about 40% or 20% may be used for validation or testing. In another example, training component 32 may randomly split the data, the exact ratio of training versus test data varies throughout. When a satisfactory model is found, training component 132 may train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 164 may leverage, via training component 132, an SQL server and a Pivotal Greenplum database for data storage and extraction purposes.

In some embodiments, training component 132 may be configured to obtain training data from any suitable source, e.g., via prediction database 160, electronic storage 122, external resources 124, network 170, and/or UI device(s) 118. The training data may comprise, image data, features, characteristics, classifications, anomalies, source geography, time of day, etc.).

In some embodiments, training component 132 may enable one or more prediction models to be trained. The training of the neural networks may be performed via several iterations. For each training iteration, a classification prediction (e.g., output of a layer) of the neural network(s) may be determined and compared to the corresponding, known classification. For example, sensed data known to identify and/or classify an object in an AOI may be input, during the training or validation, into the neural network to determine whether the prediction model may properly identify or classify a feature and/or an object in an AOI. As such, the neural network is configured to receive at least a portion of the training data as an input feature space. As shown in FIG. 1A, once trained, the model(s) may be stored in database/storage 164 of prediction database 160 and then used to classify features and/or objects in an AOI.

Electronic storage 122 of FIG. 1A comprises electronic storage media that electronically stores information. The electronic storage media of electronic storage 122 may comprise system storage that is provided integrally (i.e., substantially non-removable) with a system and/or removable storage that is removably connectable to a system via, for example, a port (e.g., a USB port, a firewire port, etc.) or a drive (e.g., a disk drive, etc.). Electronic storage 122 may be (in whole or in part) a separate component within the system, or electronic storage 122 may be provided (in whole or in part) integrally with one or more other components of a system (e.g., a user interface (UI) device 118, processor 121, etc.). In some embodiments, electronic storage 122 may be located in a server together with processor 121, in a server that is part of external resources 124, in UI devices 118, and/or in other locations. Electronic storage 122 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 122 may store software algorithms, information obtained and/or determined by processor 121, information received via UI devices 118 and/or other external computing systems, information received from external resources 124, and/or other information that enables system to function as described herein.

External resources 124 may include sources of information (e.g., databases, websites, etc.), external entities participating with a system, one or more servers outside of a system, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 124 may be provided by other components or resources included in the system. Processor 121, external resources 124, UI device 118, electronic storage 122, a network, and/or other components of the system may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

UI device(s) 118 of the system may be configured to provide an interface between one or more clients/users and the system. The UI devices 118 may include client devices such as computers, tablets and smart devices. The UI devices 118 may also include the administrative dashboard 150 and/or smart gateway 250. UI devices 118 are configured to provide information to and/or receive information from the one or more users/clients 118. UI devices 118 include a UI and/or other components. The UI may be and/or include a graphical UI configured to present views and/or fields configured to receive entry and/or selection with respect to particular functionality of the system, and/or provide and/or receive other information. In some embodiments, the UI of UI devices 118 may include a plurality of separate interfaces associated with processors 121 and/or other components of the system. Examples of interface devices suitable for inclusion in UI device 118 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 118 include a removable storage interface. In this example, information may be loaded into UI devices 118 from removable storage (e.g., a smart card, a flash drive, a removable disk) that enables users to customize the implementation of UI devices 118.

In some embodiments, UI devices 118 are configured to provide a UI, processing capabilities, databases, and/or electronic storage to the system. As such, UI devices 118 may include processors 121, electronic storage 122, external resources 124, and/or other components of the system. In some embodiments, UI devices 118 are connected to a network (e.g., the Internet). In some embodiments, UI devices 118 do not include processor 121, electronic storage 122, external resources 124, and/or other components of system, but instead communicate with these components via dedicated lines, a bus, a switch, network, or other communication means. The communication may be wireless or wired. In some embodiments, UI devices 118 are laptops, desktop computers, smartphones, tablet computers, and/or other UI devices on the network.

Data and content may be exchanged between the various components of the system through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose, the Internet Protocol (IP) defines addressing methods and structures for datagram encapsulation. Of course, other protocols also may be used. Examples of an Internet protocol include Internet Protocol version 4 (IPv4) and Internet Protocol version 6 (IPv6).

In some embodiments, processor(s) 121 may form part (e.g., in a same or separate housing) of a user device, a consumer electronics device, a mobile phone, a smartphone, a personal data assistant, a digital tablet/pad computer, a wearable device (e.g., watch), AR goggles, VR goggles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 121 is configured to provide information processing capabilities in the system. Processor 121 may comprise one or more of a digital processor, an analog processor, a digital circuit designed to process information, an analog circuit designed to process information, a state machine, and/or other mechanisms for electronically processing information. Although processor 121 is shown in FIG. 1A as a single entity, this is for illustrative purposes only. In some embodiments, processor 121 may comprise a plurality of processing units. These processing units may be physically located within the same device (e.g., a server), or processor 121 may represent processing functionality of a plurality of devices operating in coordination (e.g., one or more servers, UI devices 118, devices that are part of external resources 124, electronic storage 122, and/or other devices).

As shown in FIG. 1A, processor 121 is configured via machine-readable instructions to execute one or more computer program components. The computer program components may comprise one or more of information component 131, training component 132, prediction component 134, annotation component 136, trajectory component 38, and/or other components. Processor 121 may be configured to execute components 131, 132, 134, 136, and/or 138 by: software; hardware; firmware; some combination of software, hardware, and/or firmware; and/or other mechanisms for configuring processing capabilities on processor 21.

It should be appreciated that although components 131, 132, 134, 136, and 138 are illustrated in FIG. 1A as being co-located within a single processing unit, in embodiments in which processor 121 comprises multiple processing units, one or more of components 31, 132, 134, 136, and/or 138 may be located remotely from the other components. For example, in some embodiments, each of processor components 131, 132, 134, 136, and 138 may comprise a separate and distinct set of processors. The description of the functionality provided by the different components 131, 132, 134, 136, and/or 138 described below is for illustrative purposes, and is not intended to be limiting, as any of components 131, 132, 134, 136, and/or 138 may provide more or less functionality than is described. For example, one or more of components 131, 132, 134, 136, and/or 138 may be eliminated, and some or all of its functionality may be provided by other components 131, 132, 134, 136, and/or 138. As another example, processor 121 may be configured to execute one or more additional components that may perform some or all of the functionality attributed below to one of components 131, 132, 134, 136, and/or 138.

FIG. 1A also illustrates a smart gateway 250 connected to network 170. Smart gateway 250 receives traffic from one or more third parties over the network 170. For example, Third Party A (or other Third Parties) 190 may transmit traffic to the network 170. Smart gateway 250 routes and monitors received traffic and transmits it to respective clients 118 on the local network.

Concurrently, the smart gateway 250 and/or processor 120 may employ one or more of the trained ML models 164 in the predication database 160, based upon the training data 162, to evaluate objects in an AOI sent by Third party A 190. The object may be flagged an anomaly if it is determined that the object is different and/or exceeds an anomaly threshold (e.g., based on one or more differences between object data). The object data may appear in a database of the administrator 150. The object may also be added to the object data in the database. Moreover, an anomaly may be added to anomaly data in the database. Another trained ML model 164 may be used to further evaluate clusters of objects in the database.

In yet another embodiment, FIG. 1A illustrates an administrator 150 connected to the network 170. Administrator 150 is also operably coupled to the gateway. Administrator 150 is able to view the identification, classification, and/or labelling of objects for one or more clients/UI devices 118. Moreover, the administrator 150 may be able to create, delete and modify object data as described in the application.

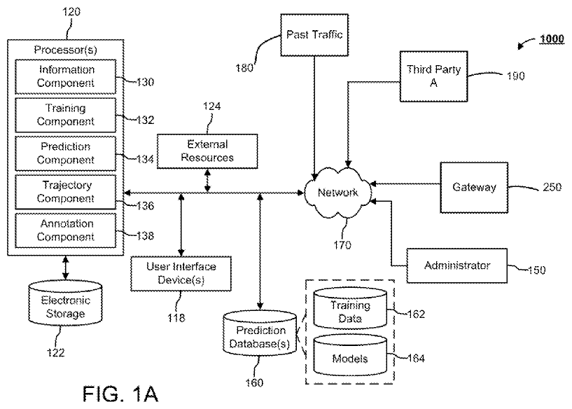

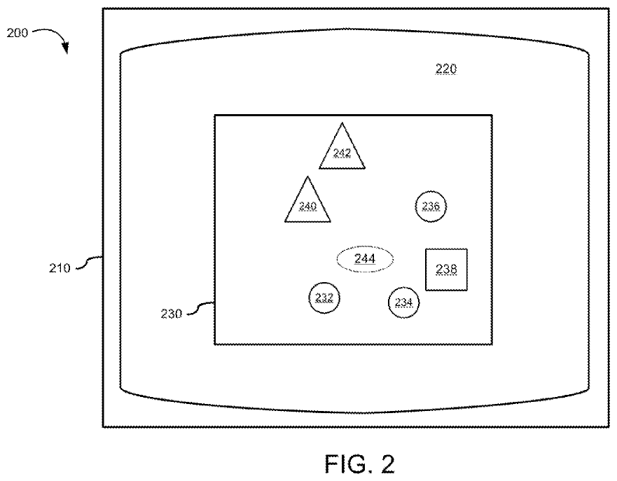

FIG. 2 is a diagram illustrating a physical environment 200 including a display 210. The display 210 may present (e.g., via a graphic user interface) imagery 220 including an overhead view of a geographic region according to an aspect of the application. According to some aspects, a user may select an AOI 230. For example, the AOI may include one or more boundaries selected from the imagery 220. An analyst may identify AOI 230. Imagery 220 intersecting the AOI 230 may be ordered and processed over an analyst-specified timeframe.

One or more objects (e.g., object 232, object 234, object 236, object 238, object 240, and/or object 242) may be detected (e.g., by object detector 104). Feature vectors may be extracted (e.g., by feature vector system 108) and similar objects may be clustered (e.g., by clustering system 114). In some aspects, analysts may be presented with clusters to rapidly label, thus quickly creating new labeled data tailored for their AOI.

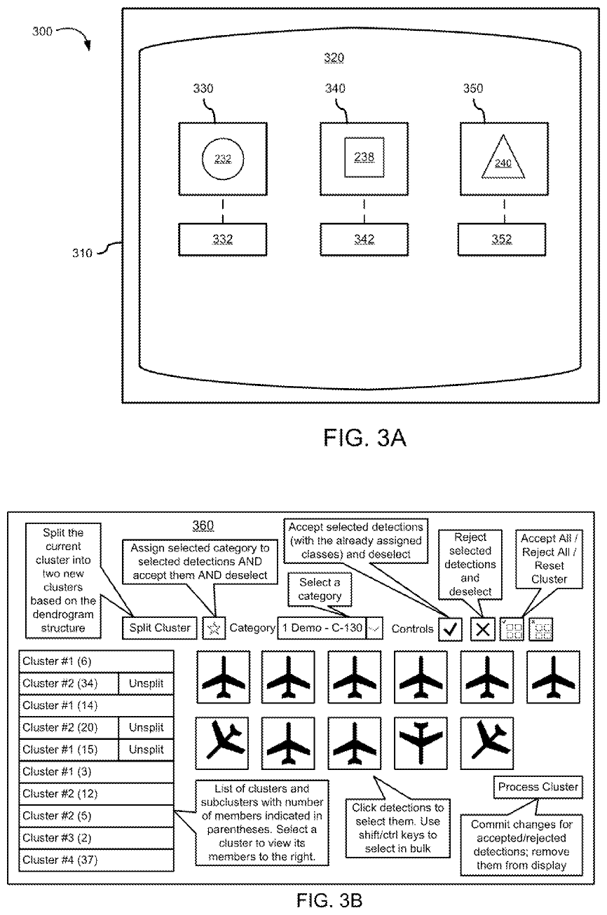

FIG. 3A is a diagram illustrating a physical environment 300 including a display 310. The display 310 may present (e.g., via a graphic user interface 320) a user (e.g., an analyst) with one or more clusters (e.g., cluster 330, cluster 340, and/or cluster 350) according to an aspect of the disclosure. According to some aspects, the user may be presented with one or more labels associated with each cluster. For example, the user may be presented with label 332 associated with cluster 330, label 342 associated with cluster 340, and/or label 352 associated with cluster 350.

In some aspects, abnormal or anomalous detections (e.g., cluster 360) within an AOI may be separated from the “normal” clusters and may be presented to the user for further investigation. For example, the abnormal or anomalous detections may include objects that have not been seen before in the AOI. Over time as additional images are acquired for an AOI, new detections may be clustered with the previously detected and labeled objects. Labels may be propagated from the labeled to the unlabeled detections in a cluster to rapidly label the new detections, as desired by the user.

According to some aspects, representation learning (e.g., feature extraction) may learn a low-dimensional summary of imagery 102 contents for downstream tasks such as classification, detection, and/or image clustering. In some aspects, unsupervised feature extraction approaches may utilize unlabeled detection data (e.g., stored in database system 118) for training. For example, as illustrated and described in FIG. 1A, unsupervised feature extractors may be trained on large amounts of images without having any class label information for the images.

In some aspects, semi-supervised approaches may benefit from supervision in the training process. Moreover, semi-supervised approaches may also benefit from available labeled data. In semi-supervised approaches, both labeled and unlabeled images may be used in training, e.g., to determine more representative features than when using either labeled or unlabeled features alone.

As illustrated in FIG. 3B, a user interface 360 may present a user with one or more detections. The user may click on the one or more detections to select them (e.g., using shift/ctrl keys to select in bulk). Moreover, the user may be presented with a list of clusters and subclusters (e.g., with a number of members indicated in parentheses). The user may select a cluster to view its members (e.g., detections) to the right.

The user interface 360 may further include one or more controls. For example, the one or more controls may include accepting selected detections (e.g., with the already assigned classes) and deselecting the detections, rejecting selected detections and deselecting the detections, and/or accepting/rejecting all detections and resetting the cluster.

Furthermore, the user interface 360 may include a capability to select a category for one or more selected detections. The selected category may be assigned to the selected detections. The user interface 360 may allow the user to process a cluster, e.g., committing changes for accepted/rejected detections and removing them from the display. The user interface 360 may also allow the user to split a cluster (e.g., into two new clusters) based on the dendrogram structure.

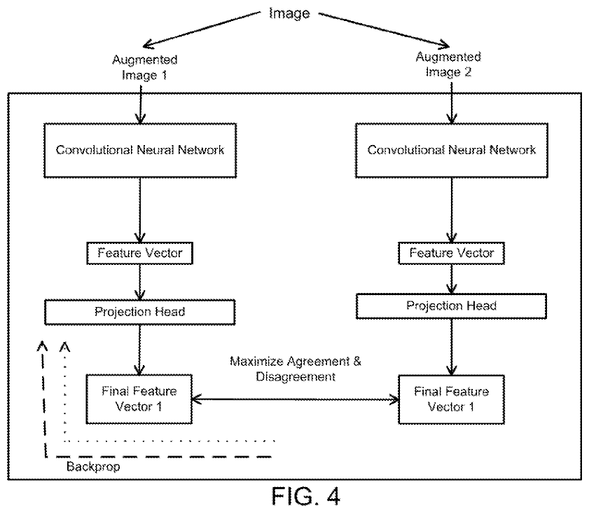

As illustrated in FIG. 4, feature space generator 106 and/or feature vector system 108 may utilize a Simple framework for Contrastive Learning of visual Representations (SimCLR) Feature Extractor 410, a feature extraction method that learns good feature representations from unlabeled images by learning an embedding space where semantically similar examples are near each other without supervision. Features may be extracted from augmented views of the same image through a network. Agreement between the features of the augmented views may be maximized and disagreement between the features of the augmented pairs and all other images may be minimized. Moreover, SimCLR Feature Extractor 410 may utilize aggressive data augmentations, large batch sizes, and/or long training runs.

As illustrated in FIG. 4, the architecture of the SimCLR Feature Extractor 410 may use a convolutional neural network (e.g., Resnet-50) backbone as the core CNN architecture for feature extraction. The SimCLR Feature Extractor 410 may use a projection head for inference and then discard the projection head.

According to some aspects, feature space generator 106 and/or feature vector system 108 may utilize a Semi-Supervised Wrapper Feature Extractor. The Semi-Supervised Wrapper Feature Extractor may utilize a wrapper for unsupervised algorithms. The Semi-Supervised Wrapper Feature Extractor may compute an unsupervised loss using all training instances, a supervised loss for those training instances which have labels, and/or a final loss using a weighted sum of the supervised and unsupervised losses. Moreover, the Semi-Supervised Wrapper Feature Extractor may transform any of the unsupervised extractors (e.g., the SimCLR Feature Extractor 410) into a semi-supervised extractor.

According to some aspects, feature space generator 106 and/or feature vector system 108 may utilize a pseudo-label feature extractor (e.g., Fixmatch). The pseudo-label feature extractor may utilize a semi-supervised algorithm that may compute loss for unlabeled images using pseudo-labels. For labeled images, the algorithm may compute a normal supervised loss. For unlabeled images, the algorithm may first predict a pseudo-label using a weakly-augmented view of the image. If the prediction's confidence is sufficiently high, the pseudo-label feature extractor may treat that pseudo-label as ground truth for a strongly-augmented view of the same image. The final loss may be a weighted sum of the supervised loss and the resulting unlabeled loss.

According to some aspects, clustering system 114 may utilize unsupervised clustering algorithms for feature vector clustering. For example, clustering system 114 may require the number of clusters to be specified a priori and/or have relatively few hyperparameters that impact the results (e.g., allowing the clusters to be compared easily).

According to some aspects, clustering system 114 may utilize a Hierarchical Agglomerative Clustering (HAC) algorithm for feature vector clustering. The HAC algorithm may be a bottom-up clustering algorithm that works by combining instances and may subsequently group/cluster the instances (e.g., using a measure of dissimilarity between sets of instances). The HAC algorithm may use an appropriate pair-wise distance metric and a linkage criterion which specifies the dissimilarity of sets as a function of the pairwise distances of their members. Moreover, every instance may be placed in its own singleton cluster and then the HAC algorithm may build a hierarchy from the individual elements by progressively merging clusters. From the HAC algorithm's output, a dendrogram may be constructed depicting the hierarchy. The dendrogram may be subsequently cut at different distance thresholds to produce different numbers of clusters at different granularities as desired. For example, the Ward linkage criterion (e.g., which aims to minimize the total within-cluster variance) and the Euclidean distance. According to some aspects, the HAC algorithm may utilize a Scikit-Learn implementation of the algorithm.

According to some aspects, clustering system 114 may utilize a Hierarchical Agglomerative Clustering (HAC) algorithm for feature vector clustering. According to some aspects, the HAC algorithm may combine instances, and subsequently groups/clusters of instances, using a measure of dissimilarity between sets of instances. The HAC algorithm may use an appropriate pair-wise distance metric and a linkage criterion which specifies the dissimilarity of sets as a function of the pairwise distances of their members. A hierarchy may be built from the individual elements by progressively merging clusters. From the algorithm's output, a dendrogram may be constructed depicting a hierarchy of clusters and the dendrogram may be cut at different distance thresholds to produce different numbers of clusters at different granularities. Accordingly, there may be no need to specify the number of clusters a priori and clusters at multiple levels may be obtained without re-computation. According to some aspects, the HAC algorithm may be practical to operationalize. For example, the computation may be done once, asynchronously, and exploration of the cluster hierarchy may be performed by the user interface after the fact, with no additional server-side computation.

According to some aspects, the user may be exposed to the hierarchical clustering output in a user interface. For example, when the user requests an AOI to be clustered, they may initially be presented with a few clusters from the top of the hierarchy. The user may then click on clusters to view and annotate the detections within the clusters. If there are too many different types of objects in a cluster to efficiently label it, the analyst may choose to “split” the cluster into two “subclusters” automatically (e.g., based on the underlying dendrogram) by clicking a button in the interface. Those clusters may be further split, or even merged back together, as desired. Moreover, an analyst may quickly drill down to clusters that are at a desired level of granularity to enable bulk labeling (e.g., with just a few clicks of a mouse or a user interface). Because the full dendrogram may be produced after running the clustering algorithm just once, “split” actions may be performed very quickly with no additional server-side computation (e.g., making this approach highly scalable).

According to some aspects, anomaly detection may be performed to identify object detections that are unusual for an AOI. Fer example, for the AOI, multiple images may contain detections, some or all of which may be unclassified beyond a very high level in our class hierarchy (e.g., aircraft, maritime). Object detections that are unusual for the AOI may be identified where the objects belong to a granular class not before seen, or infrequently seen, in that AOI. Moreover, such a determination may be made without using class information, since the class information may not be available. According to some aspects, anomalous detections may be identified from a set of feature vectors for all detections in an AOI. According to some aspects, anomaly detection approaches may include one or more of K-Nearest Neighbors anomaly detection or One-Class SVMs.

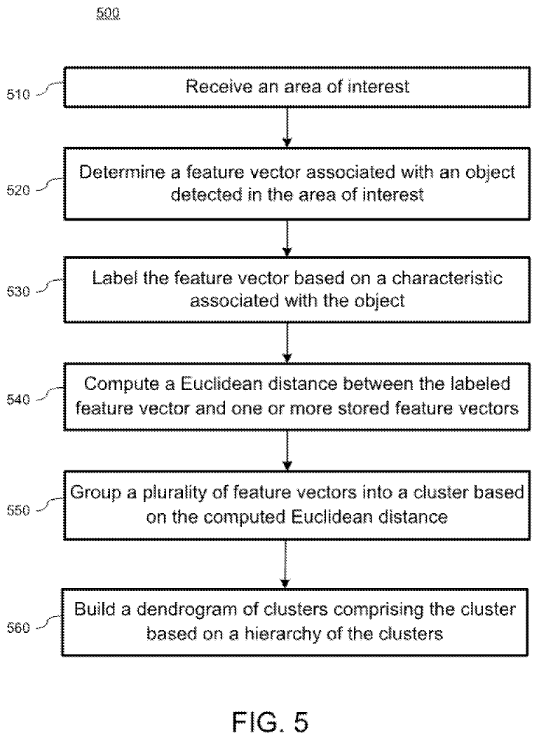

FIG. 5 illustrates an exemplary flowchart of a method 500 for identification, labelling, classification, and/or anomaly detection in over-head geospatial or satellite footage in accordance with the present disclosure. The method 500 may be performed at a network device, UE, desktop, laptop, mobile device, server device, or by multiple devices in communication with one another. In some examples, the method 500 is performed by processing logic, including hardware, firmware, software, or a combination thereof. In some examples, the method 500 is performed by a processor executing code stored in a computer-readable medium (e.g., memory).

As shown in method 500, at block 510, an AOI may be received. Fer example, the AOI may be selected by a user. Moreover, the AOI may be associated with one or more of a polygon on a map or a particular event.

As shown in method 500, at block 520, a feature vector associated with an object detected in the AOI may be determined. For example, the feature vector may comprise a bounding box associated with the object and/or summarize the visual appearance of the object. The feature vector may be determined based on one or more of feature extraction, determining the object is not part of a background, and/or comparing the object to previously detected objects.

As shown in method 500, at block 530, the feature vector may be labeled based on a characteristic associated with the object.

As shown in method 500, at block 540, a Euclidean distance between the labeled feature vector and one or more stored feature vectors may be computed.

As shown in method 500, at block 550, a plurality of feature vectors may be grouped into a cluster (e.g., using hierarchical and/or agglomerative clustering) based on the computed Euclidean distance. For example, feature dimensionality of feature vectors may be reduced by clustering the feature vectors.

As shown in method 500, at block 560, a dendrogram of clusters may be built depicting a hierarchy of the clusters. Moreover, the dendrogram of clusters may be presented to a user by a user interface or used to enable the splitting or merging of clusters in response to a user's input via the graphical user interface. The objects may be labeled in bulk (e.g., by the user) based on the dendrogram of clusters.

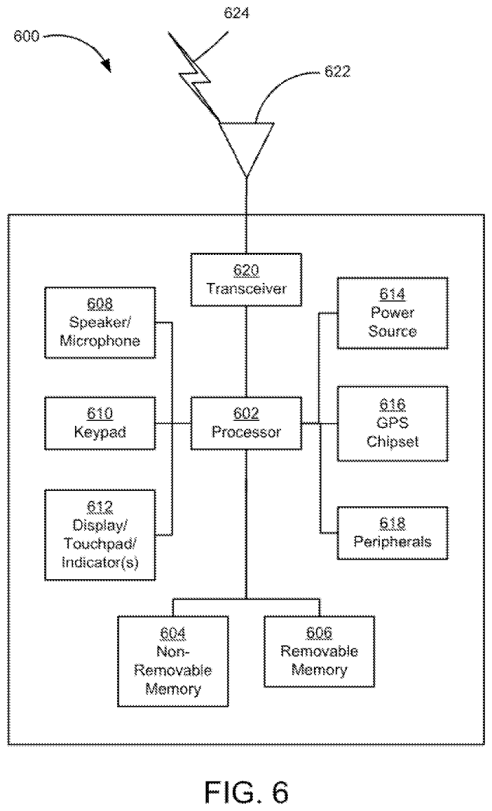

FIG. 6 is a block diagram of an exemplary hardware/software architecture of a node 600 of a network, such as clients, servers, or proxies, which may operate as an server, gateway, device, or other node in a network. The node 600 may include a processor 602, non-removable memory 604, removable memory 606, a speaker/microphone 608, a keypad 610, a display, touchpad, and/or indicators 612, a power source 614, a global positioning system (GPS) chipset 616, and other peripherals 618. The node 600 may also include communication circuitry, such as a transceiver 620 and a transmit/receive element 622 in communication with a communications network 624. The node 600 may include any sub-combination of the foregoing elements while remaining consistent with an embodiment.

The processor 602 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 602 may execute computer-executable instructions stored in the memory (e.g., memory 604 and/or memory 606) of the node 600 in order to perform the various required functions of the node 600. For example, the processor 602 may perform signal coding, data processing, power control, input/output processing, and/or any other functionality that enables the node 600 to operate in a wireless or wired environment. The processor 602 may run application-layer programs (e.g., browsers) and/or radio-access-layer (RAN) programs and/or other communications programs. The processor 602 may also perform security operations, such as authentication, security key agreement, and/or cryptographic operations. The security operations may be performed, for example, at the access layer and/or application layer.

As shown in FIG. 6, the processor 602 is coupled to its communication circuitry (e.g., transceiver 620 and transmit/receive element 622). The processor 602, through the execution of computer-executable instructions, may control the communication circuitry to cause the node 600 to communicate with other nodes via the network to which it is connected. While FIG. 6 depicts the processor 602 and the transceiver 620 as separate components, the processor 602 and the transceiver 620 may be integrated together in an electronic package or chip.

The transmit/receive element 622 may be configured to transmit signals to, or receive signals from, other nodes, including servers, gateways, wireless devices, and the like. For example, in an embodiment, the transmit/receive element 622 may be an antenna configured to transmit and/or receive RF signals. The transmit/receive element 622 may support various networks and air interfaces, such as WLAN, WPAN, cellular, and the like. In an embodiment, the transmit/receive element 622 may be an emitter/detector configured to transmit and/or receive IR, UV, or visible light signals, for example. In another embodiment, the transmit/receive element 622 may be configured to transmit and receive both RF and light signals. The transmit/receive element 622 may be configured to transmit and/or receive any combination of wireless or wired signals.

In addition, although the transmit/receive element 622 is depicted in FIG. 6 as a single element, the node 600 may include any number of transmit/receive elements 622. More specifically, the node 600 may employ multiple-input and multiple-output (MIMO) technology. Thus, in an embodiment, the node 600 may include two or more transmit/receive elements 622 (e.g., multiple antennas) for transmitting and receiving wireless signals.

The transceiver 620 may be configured to modulate the signals to be transmitted by the transmit/receive element 622 and to demodulate the signals that are received by the transmit/receive element 622. As noted above, the node 600 may have multi-mode capabilities. Thus, the transceiver 620 may include multiple transceivers for enabling the node 600 to communicate via multiple RATs, such as Universal Terrestrial Radio Access (UTRA) and IEEE 802.11, for example.

The processor 602 may access information from, and store data in, any type of suitable memory, such as the non-removable memory 604 and/or the removable memory 606. For example, the processor 602 may store session context in its memory, as described above. The non-removable memory 604 may include random-access memory (RAM), read-only memory (ROM), a hard disk, or any other type of memory storage device. The removable memory 606 may include a subscriber identity module (SIM) card, a memory stick, a secure digital (SD) memory card, and the like. In other embodiments, the processor 602 may access information from, and store data in, memory that is not physically located on the node 600, such as on a server or a home computer.

The processor 602 may receive power from the power source 614 and may be configured to distribute and/or control the power to the other components in the node 600. The power source 614 may be any suitable device for powering the node 600. For example, the power source 614 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 602 may also be coupled to the GPS chipset 616, which is configured to provide location information (e.g., longitude and latitude) regarding the current location of the node 600. The node 600 may acquire location information by way of any suitable location-determination method while remaining consistent with an embodiment.

The processor 602 may further be coupled to other peripherals 618, which may include one or more software and/or hardware modules that provide additional features, functionality, and/or wired or wireless connectivity. For example, the peripherals 618 may include various sensors such as an accelerometer, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, an Internet browser, and the like.

The node 600 may be embodied in other apparatuses or devices, such as a sensor, consumer electronics, a wearable device such as a smart watch or smart clothing, a medical or eHealth device, a robot, industrial equipment, a drone, and a vehicle, such as a car, truck, train, or airplane. The node 600 may connect to other components, modules, or systems of such apparatuses or devices via one or more interconnect interfaces, such as an interconnect interface that may comprise one of the peripherals 618.

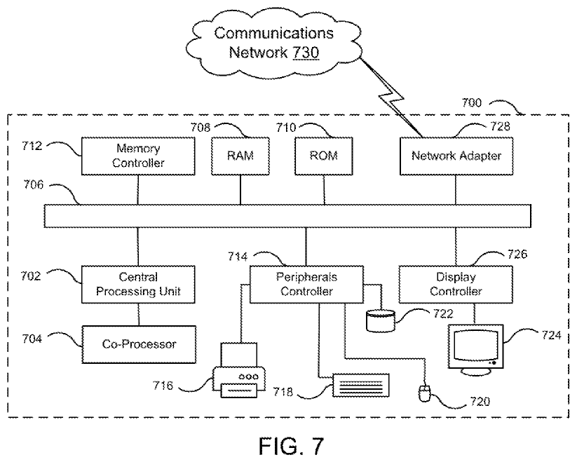

FIG. 7 is a block diagram of an exemplary computing system 700 that may be used to implement one or more nodes (e.g., clients, servers, or proxies) of a network, and which may operate as a server, gateway, device, or other node in a network. For example, computing system 700 may include a network adapter 728 in communication with a communications network 730. The computing system 700 may comprise a computer or server and may be controlled primarily by computer-readable instructions, which may be in the form of software, by whatever means such software is stored or accessed. Such computer-readable instructions may be executed within a processor, such as a central processing unit (CPU) 702, to cause the computing system 700 to effectuate various operations. In many known workstations, servers, and personal computers, the CPU 702 is implemented by a single-chip CPU called a microprocessor. In other machines, the CPU 702 may comprise multiple processors. A co-processor 704 is an optional processor, distinct from the CPU 702 that performs additional functions or assists the CPU 702.

In operation, the CPU 702 fetches, decodes, executes instructions, and transfers information to and from other resources via the computer's main data-transfer path, a system bus 706. Such a system bus 706 connects the components in the computing system 700 and defines the medium for data exchange. The system bus 706 typically includes data lines for sending data, address lines for sending addresses, and control lines for sending interrupts and for operating the system bus 706. An example of such a system bus 706 is the PCI (Peripheral Component Interconnect) bus.

Memories coupled to the system bus 706 include RAM 708 and ROM 710. Such memories include circuitry that allows information to be stored and retrieved. The ROM 710 generally contains stored data that cannot easily be modified. Data stored in the RAM 708 may be read or changed by the CPU 702 or other hardware devices. Access to the RAM 708 and/or the ROM 710 may be controlled by a memory controller 712. The memory controller 712 may provide an address translation function that translates virtual addresses into physical addresses as instructions are executed. The memory controller 712 may also provide a memory protection function that isolates processes within the system and isolates system processes from user processes. Thus, a program running in a first mode may access only memory mapped by its own process virtual address space. It cannot access memory within another process's virtual address space unless memory sharing between the processes has been set up.

In addition, the computing system 700 may contain a peripherals controller 714 responsible for communicating instructions from the CPU 702 to peripherals, such as a printer 716, a keyboard 718, a mouse 720, and a disk drive 722.

A display 724, which is controlled by a display controller 726, is used to display visual output generated by the computing system 700. Such visual output may include text, graphics, animated graphics, and video. The display 724 may be implemented with a CRT-based video display, an LCD-based flat-panel display, gas plasma-based flat-panel display, or a touch-panel. The display controller 726 includes electronic components required to generate a video signal that is sent to the display 724.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed:

1. A method comprising:
receiving an area of interest;
determining, by a trained machine learning (ML) model, a feature vector associated with an object detected in the area of interest;
labeling the feature vector based on a characteristic associated with the object;
computing a Euclidean distance between the labeled feature vector and one or more stored feature vectors;
grouping a plurality of feature vectors into a cluster based on the computed Euclidean distance;
building a dendrogram of clusters depicting a hierarchy of the clusters;
labeling the object based on the dendrogram of clusters; and
presenting, by a user interface, a user with the labeled object.

2. The method of claim 1, wherein the area of interest is bounded by a polygon on a map.

3. The method of claim 1, wherein the area of interest is associated with an event.

4. The method of claim 1, wherein the feature vector comprises a bounding box associated with the object.

5. The method of claim 1, wherein the feature vector is determined based on feature extraction.

6. The method of claim 1, wherein the feature vector summarizes a visual appearance of the object.

7. The method of claim 1, wherein determining the feature vector comprises determining the object is not a part of a background associated with the area of interest.

8. The method of claim 1, wherein determining the feature vector comprises comparing an object to a previously detected object.

9. The method of claim 1, further comprising presenting, by a user interface, a user with the dendrogram of clusters.

10. A method comprising:
determining, by a trained machine learning model, an anomaly score for a detected object;
determining an anomaly threshold;
determining an anomaly based on comparing the anomaly score to the threshold;
removing the anomaly from a set of detections;
determining an anomaly cluster comprising the anomaly; and
storing the anomaly cluster, wherein the anomaly score for the detected object is based on the anomaly cluster.

11. The method of claim 10, further comprising:
transmitting, to a user, the anomaly cluster; and
receiving, from the user, a confirmation or a rejection of the anomaly cluster, wherein the anomaly cluster is determined based on the confirmation or the rejection.

12. The method of claim 10, further comprising adding the determined anomaly to a set of anomalies.

13. The method of claim 10, wherein the anomaly is determined based on an anomaly detector.

14. The method of claim 13, further comprising training the anomaly detector.

15. The method of claim 10, wherein the anomaly threshold is determined based on an area of interest associated with the detected object.

16. A computer program product comprising:
a computer-readable storage medium; and
instructions stored on the computer-readable storage medium that, when executed by a processor, causes the processor to:
receive an area of interest;
determine, by a trained machine learning (ML) model, a feature vector associated with an object detected in the area of interest;
label the feature vector based on a characteristic associated with the object;
compute a Euclidean distance between the labeled feature vector and one or more stored feature vectors;
group a plurality of feature vectors into a cluster based on the computed Euclidean distance;
build a dendrogram of clusters comprising the cluster and depicting a hierarchy of the clusters;
label the object based on the dendrogram of clusters; and
present, by a user interface, a user with the labeled object.

17. The computer program product of claim 16, wherein the feature vector comprises a bounding box associated with the object.

18. The computer program product of claim 16, wherein the feature vector summarizes a visual appearance of the object.

19. The computer program product of claim 16, wherein determining the feature vector comprises determining the object is not a part of a background associated with the area of interest.

20. The computer program product of claim 16, wherein determining the feature vector comprises comparing an object to a previously detected object.
